(19) United States
(12) Patent Application Publication
(10) Pub. No.: US 2007/0044762 A1
(43) Pub. Date: Mar. 1, 2007

(54) Movable venturi carburetor of less fuel consumption, pollutant emission, and cost

(76) Inventor: Hui-Tzeng Ting, New York City, NY (US)

Correspondence Address: HUI-TZENG TING;#5E, 601 MORRIS AVE., NEW YORK, NY, 10451-4768, US

(21) Appl. No.: 11/217,119

(22) Filed: Sep. 1, 2005

(51) Int. Cl. F02M 7/17; F02M 9/06

(52) U.S. Cl. 123/439; 261/44.3

(57) ABSTRACT

A multiple cylinder gasoline or alcohol engine has one fuel supply means per cylinder, and one digital electric logic circuit to control said fuel supply and ignition spark plug of each cylinder such that activated cylinder quantity is increased from one to all by steps first, and then all cylinders fuel supply are enriched from lean to normal and to rich air-fuel ratio.

This invention relates to the carburetor of movable venturi and adjustable fuel emission of tiny droplets and variable activation of multiple cylinders of gasoline or alcohol internal combustion engines to minimize fuel consumption and pollutant emission with least expensive means.

FIG. 1 shows the cross-sectional elevation of said carburetor, which is designed for VW-1300 sedan of four cylinders as an example. The air stream passage 1 is of 30 mm square with 7 mm thick wall. It can be cut from a long tube. 5 mm thick plates 3, 4 and 5 (Fig 1B also) are hinged with pin 6 and tied with screws and nuts 8 and tension spring 9 to form a venturi effect with said air passage 1. It can be pushed with force 2 (from said engine gas peddle mechanism, not shown) at cap 11 against rod 7 to narrow said venturi effect throat to increase the suction of fuel (said gasoline or alcohol) from nozzle 15. When said force is relaxed, compression spring 10 pushes said cap 11 back to a position set by screw and nut 22 affixed to casing 12, and enlarges said throat to reduce fuel emission for the case of low power output. In case of high power output, said throat plate 4 is stopped by set-screw and nut 23. Said casing 12 is affixed to said air passage 1 by screws 13.

The lower side of said air passage (FIGS. 1 and 1A) has a cylindrical lug 14 with cut-off flat top and one screw hole to accommodate one anchor bolt to said engine inlet. It is press-fitted into said air passage. To its left at centerline 14a, a symmetrical lug to 14 (not shown) is located.

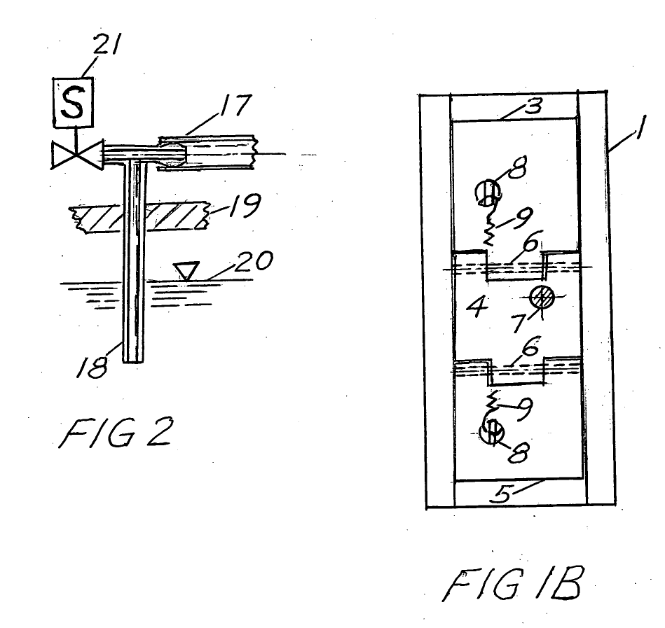

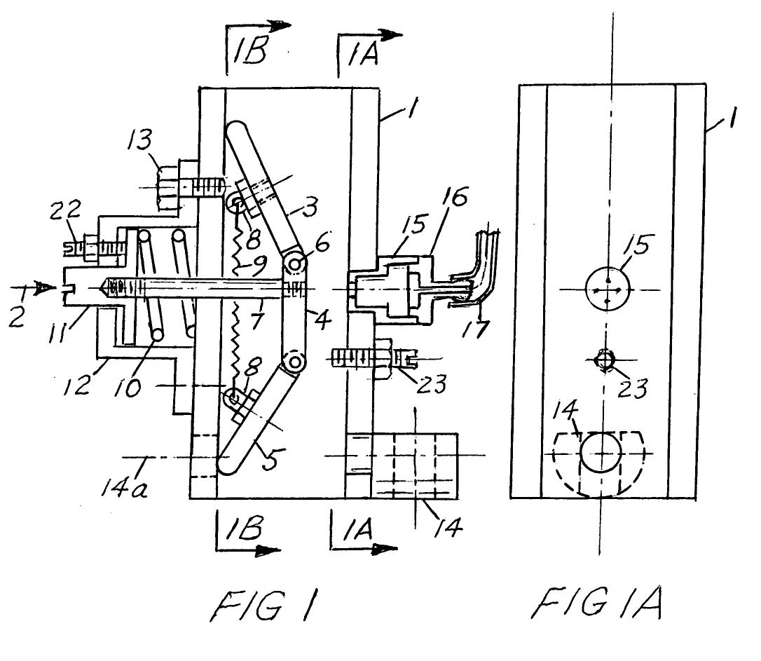

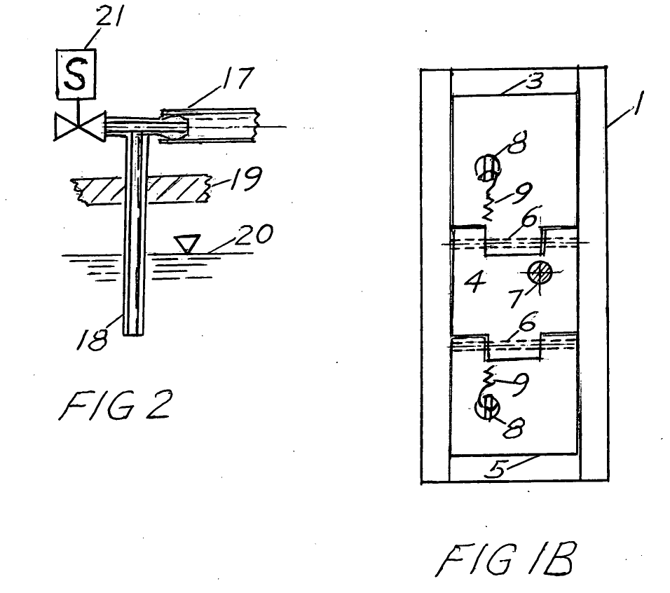

Said fuel nozzle 15 (FIGS. 1 and 1A) has a cap 16 connected to Teflon fuel tube 17, which is connected to a three-way suction tube 18 (FIG. 2) entering the lid 19 of fuel chamber (not shown) to suck fuel 20. Said three way tube 18 has one electric solenoid valve 21 attached to its top to open it to air through a filter (not shown) to make a vent to de-activate the suction effect of said venturi. As an alternative design, said solenoid valve can have one end connected to said fuel 20 and the other end connected to said tube 17 without opening to ambient air so as to cut-off or let-go fuel supply to said fuel nozzle by said solenoid valve. This method needs a more expensive solenoid valve, but can eliminate time lag due to filling up said fuel tube after it is emptied by de-activating air. However, this method is less expensive than the existing electric fuel injecting system.

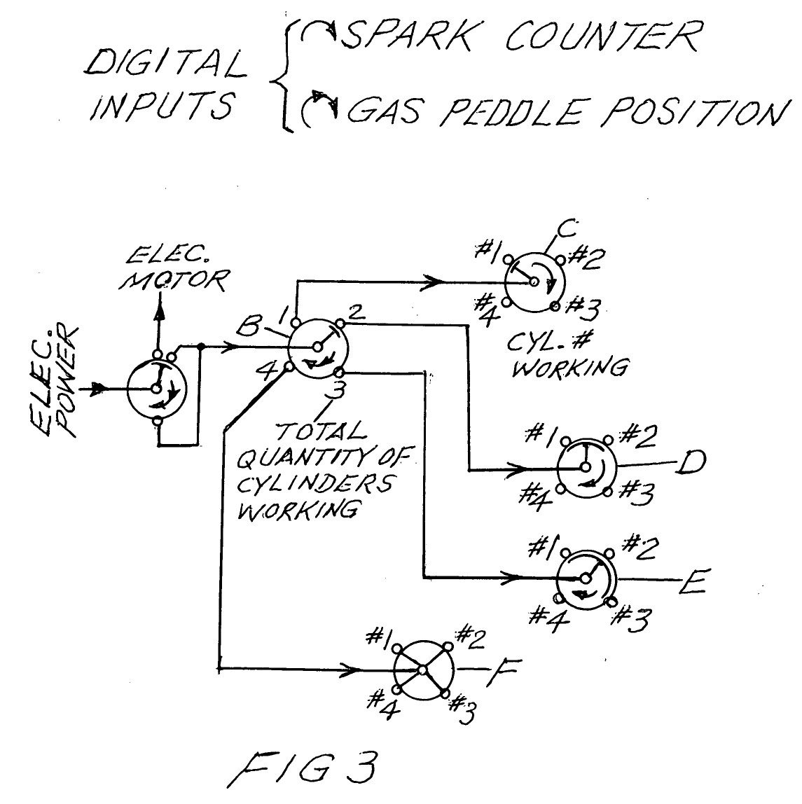

FIG. 3 shows how an equivalent electric logic circuit (not shown) works to control the fuel emission to a venturi and its associated cylinder of said engine of multiple cylinders (which total four in this case of illustration). Each cylinder is provided with one venturi and one spark plug with same electricity input, which can be cut off by said logic circuit to minimize fuel consumption and pollutant emission.

In FIG. 3, electric rotary switches A, B, C, D, and E plus one multiple connection F are used to represent the function of said logic circuit for clarity. A circular arc with one arrowhead (as shown in symbols on top of FIG. 3) represents the input of ignition spark counter. A circular arc with two arrowheads represents said engine gas peddle position, which is digitized to suit said logic circuit.

As shown in FIG. 3, at its left side electric power is used to run the electric motor when said gas peddle position of switch A is at the position of allowing power to said electric motor and to switch B. Switch B allows a total of one to four engines to get electric input to activate said spark plugs and fuel nozzle, depending on the gas peddle position. Switches A, B and C working together can make one of said four cylinders work to take low load, and said cylinders will rotate activity by the input of spark counter so as to keep all cylinders warm. When more power output is needed, switches A and B will work together in response to the next digital gas peddle position to make two cylinders work jointly through switch D, or to make three cylinders to work jointly through switch E, or to make all four cylinders to work jointly through multiple joint F. When only one, two or three cylinders are working, said spark counter input will make all four cylinders rotate activity to keep them warm.

When only one cylinder is working, said electric motor can also step in if the power is not sufficient as controlled by switches A, B and C.

In this case the conventional engine idling and accelerating conditions can be avoided because they burn more fuel and emit more pollutant.

For the case of only one cylinder of the sample VW-1300 engine is working, a calculation is done as follows:

(1) Said fuel nozzle 15 has eight holes of 0.4 mm in diameter. Density of air is 29 grams in 22.4 liters. Density of gasoline is 710 g per liter. Engine suction volumetric efficiency is 0.70 Fuel hole emission coefficient is 0.60 Each engine cylinder has one carburetor with possible sharing of fuel chambers.

(2) At engine speed of 600 rpm, and said throat opening is 3 mm, 7 mm or 10 mm, the air-fuel ratio would be 6.35, 14.8 or 21.2 respectively.

(3) At engine speed of 4000 rpm, and said throat opening is 7 mm or 10 mm, the air-fuel ratio would be 15.3 or 22.5 respectively.

These are acceptable conditions for the ideal air-fuel ratio of 15. The optimum design depends on the prototype performance test. It can be seen that the new carburetor is a feasible device.

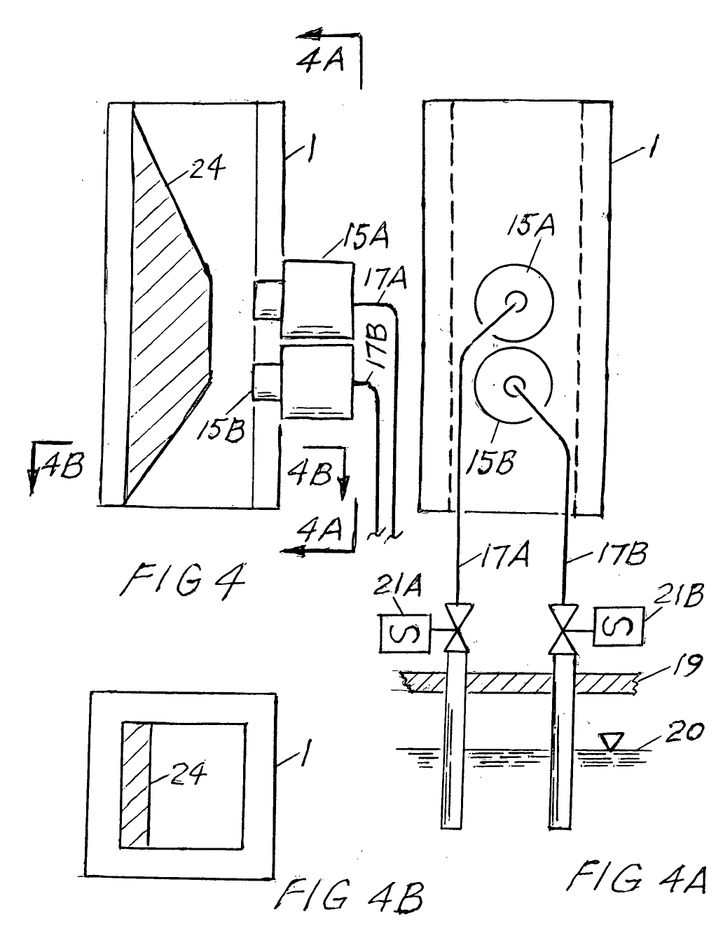

As an alternative design, said venturi plates 3, 4 and 5 (FIG. 1) are changed to one solid piece 24 (FIGS. 4 and 4B) affixed to said air stream passage 1 with screws (not shown). Said fuel nozzle 15 is shown as 15A (FIGS. 4 and 4A) in symbol or diagram. Also press-fitted into said air passage 1 is additional fuel nozzle 15B (FIGS. 4 and 4A) in the middle of said venturi throat below nozzle 15A. 15A and 15B are independently controlled by electric solenoid valves 21A and 21B respectively. They are connected to fuel chamber with Teflon tubes 17A and 17B (FIGS. 4 and 4A) and enter fuel chamber lid 19 to suck fuel 20 (FIG. 4A). 15A and 15B have different quantity of tiny fuel emitting holes such that:

(1) when only 15A is emitting fuel, each cylinder receives a mixture of lean air-fuel ratio;

(2) when only 15B is emitting fuel, each cylinder received a mixture of normal or ideal air-fuel ratio;

(3) when both 15A and 15B are emitting fuel, each cylinder receives a mixture of rich air-fuel ratio.

Let the car driver's intent and the engine temperature be the digital inputs to said electric logic circuit. It is feasible to control the car performance at low cost with low fuel consumption and low pollutant emission.

In large quantity production, the multiple tiny holes of fuel nozzles can be pierced with multiple needle points pressing on thin plastic or metal sheets first, and then use a punching machine to cut out the needed size to fit into the nozzle surface. The small piece of nozzle surface can be attached to nozzle body with plastic or metal soldering technique. The means of production is cheap.

I claim:

1) A method to bum gasoline or alcohol efficiently with low equipment cost in a multiple cylinder car engine by providing one fuel supply means of tiny fuel droplets to each cylinder, and using one digital electric logic circuit to activate or de-activate said cylinders according to the input of car driver's intent and engine temperature condition such that the engine starts with one activated cylinder plus possible assistance with electric motor, and then increases the activated quantity of cylinders by one at each step to all the cylinders.

2) In connection to claim 1), said engine cylinders are set to lean combustion of air-fuel mixture first, and then set to normal or ideal combustion of air-fuel mixture after all cylinders are activated with lean combustion, and then set to rich combustion of air-fuel mixture for maximum power output.

3) In connection to claim 1), said fuel supply means is controlled by electric solenoid valves to cut of or let go the fuel supply from the fuel chamber of the carburetor of each said cylinder.

4) In connection to claims 1), 2) and 3), each said cylinder has its own carburetor with fuel suction venturi and electric solenoid controlled fuel supply nozzle of which the fuel is emitted from multiple tiny holes, and of which the venturi is formed with movable plates in the square or rectangular air stream body of said carburetor, and can be controlled with a mechanical mechanism by said engine operator to change air-fuel mixture ratio.

5) In connection to claim 4), said movable plates are combined into one solid piece, and said fuel supply nozzles are multiple and are independently controlled by electric solenoid valves through said electric logic circuit and engine operator's intent to change air-fuel mixture ratio.
